(19) United States
(12) Patent Application Publication
(10) Pub. No.: US 2026/0118485 A1
(43) Pub. Date: Apr. 30, 2026

(54) LIGHT DETECTION DEVICE AND ACTIVE LIGHT SENSING SYSTEM

(71) Applicant: Sony Semiconductor Solutions Corporation, Kanagawa (JP)

(72) Inventor: Renato FERRACINI ALVES, Kanagawa (JP)

(73) Assignee: Sony Semiconductor Solutions Corporation, Kanagawa (JP)

(21) Appl. No.: 18/931,622

(22) Filed: Oct. 30, 2024

(51) Int. Cl. G01S 7/481; G01S 7/4865; G01S 17/10

(52) U.S. Cl. CPC G01S 7/4816; G01S 7/4865; G01S 17/10

(57) ABSTRACT

A light detection device, wherein the light detection includes:
a photodetection layer configured to perform photoelectric conversion on light with a predetermined wavelength;
a linear polarizer, and
a quarter-wave plate, wherein the quarter-wave plate is configured to circularly polarize light that has passed through the linear polarizer.

### TECHNICAL FIELD

The present disclosure generally pertains to a light detection device and an active light sensing system.

### TECHNICAL BACKGROUND

Generally, active light sensing systems are known, for example, time-of-flight (“ToF”) systems.

Active light sensing systems use an active light source such as a laser diode or laser diode array to illuminate a scene to obtain information about the scene, for example, depth information to construct a digital three-dimensional (“3D”) image of the scene.

The active light emitted by the active light source is reflected at the scene and the reflected light is acquired by an imaging system or light detection system of the active light sensing system to obtain the information about the scene.

Typically, the light detection system has a pixel array with multiple light detection pixels or devices for acquiring the reflected active light.

However, stray light may occur in the light detection system, as generally known. The stray light may follow various paths, for example, the light incident onto one light detection pixel may cause reflections inside the light detection system such that a part of the incident light reaches also one or more neighboring light detection pixels.

Stray light may limit a dynamic range, signal-to-noise ratio (“SNR”) or contrast ratio of the system and may generate artifacts such as ghost, reflections, color shifts, ring patterns and other lens flares.

Generally, the stray light should be reduced as much as possible, in particular, for applications involving safety features in order to increase a robustness of the safety feature.

Although there exist techniques for light detection devices and active light sensing systems, it is generally desirable to improve the existing techniques.

### SUMMARY

According to a first aspect, the disclosure provides a light detection device comprising:
a photodetection layer configured to perform photoelectric conversion on light with a predetermined wavelength;
a linear polarizer; and
a quarter-wave plate, wherein the quarter-wave plate is configured to circularly polarize light that has passed through the linear polarizer.

According to a second aspect, the disclosure provides an active light sensing system comprising:
an active light source configured to emit light with a predetermined wavelength and a predetermined polarization;
a light detection device including:
   a photodetection layer configured to perform photoelectric conversion on light with the predetermined wavelength;
   a linear polarizer;
   a quarter-wave plate, wherein the quarter-wave plate is configured to circularly polarize light that has passed through the linear polarizer; and
wherein the linear polarizer and the quarter-wave plate are configured to let incoming light with the predetermined polarization pass.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 schematically illustrates in a block diagram an embodiment of a source of optical crosstalk in a light detection system;

FIG. 2 schematically illustrates in a block diagram a situation in which optical crosstalk occurs;

FIG. 3 schematically illustrates in a block diagram an embodiment of an active light sensing system;

FIG. 4 schematically illustrates in a block diagram an embodiment of an active light source;

FIG. 5 schematically illustrates in a block diagram an embodiment of an active light source;

FIG. 6 schematically illustrates in a block diagram an embodiment of a light detection system;

FIG. 7 schematically illustrates in a block diagram an embodiment of a light detection sensor;

FIG. 8 schematically illustrates in a block diagram an embodiment of an array of light detection devices in a plan view;

FIG. 9 schematically illustrates in a block diagram an embodiment of a light detection device;

FIG. 10 schematically illustrates in a block diagram an embodiment of a light detection device;

FIG. 11 schematically illustrates in a block diagram an embodiment of a single-photon avalanche diode;

FIG. 12 schematically illustrates in a block diagram an embodiment of a working principle of an embodiment of a light detection device;

FIG. 13 schematically illustrates in a block diagram an embodiment of a working principle of an embodiment of a light detection device;

FIG. 14 schematically illustrates in a block diagram an embodiment of a working principle of an embodiment of an active light sensing system; and

FIG. 15 schematically illustrates in a block diagram an embodiment of a light detection device.

### DETAILED DESCRIPTION OF EMBODIMENTS

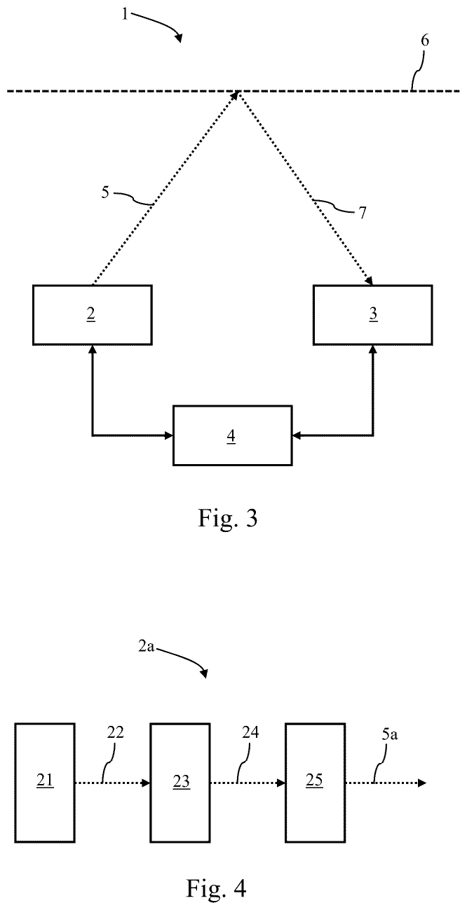

Before a detailed description of the embodiments under reference of FIG. 3 is given, general explanations are made.

As mentioned in the outset, stray light or optical crosstalk may occur in an imaging system or light detection system, for example, inter-pixel optical crosstalk may occur where the light incident onto one light detection pixel may cause reflections inside the light detection system such that a part of the incident light is finally incident also on one or more neighboring light detection pixels.

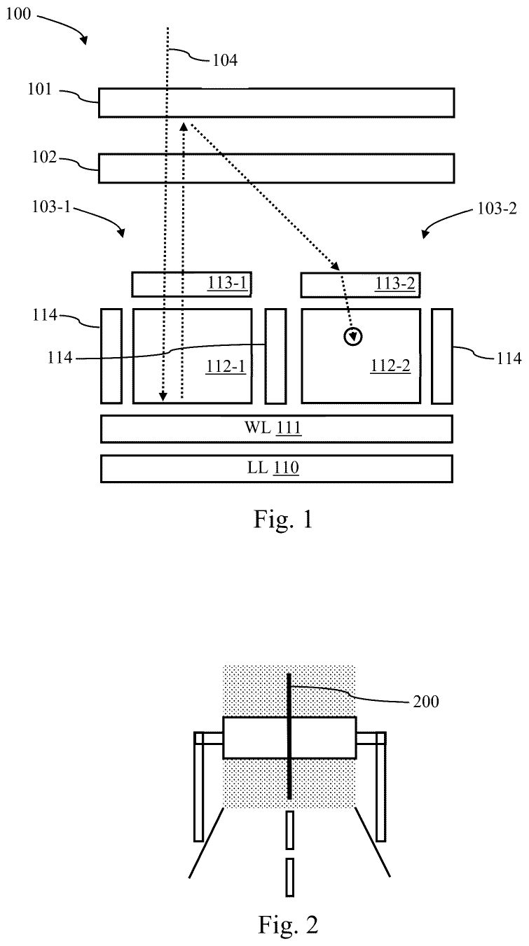

For enhancing the general understanding of the present disclosure, an embodiment of a source of optical crosstalk in a light detection system and a situation in which optical crosstalk occurs are discussed in the following under reference of FIG. 1 and FIG. 2, which schematically illustrate the situation and the embodiment in a block diagram.

Referring to FIG. 1, the light detection system 100 includes a lens stack 101, an optical band-pass filter 102 and a light detection sensor, wherein the light detection sensor includes a plurality of light detection devices or pixels, a wiring layer 111 and a logic layer 110.

For the sake of illustration only, FIG. 1 shows only a first light detection device 103-1 and a neighboring light detection device 103-2 of the light detection sensor to illustrate a source of stray light or optical crosstalk.

Each light detection device 103-1 and 103-2 includes a photodetection layer 112-1 and 112-2, respectively, an on-chip micro lens 113-1 and 113-2, respectively, and a trench 114 which surrounds the photodetection layers 112-1 and 112-2.

Generally, there may or may no air gap or a further layer between the on-chip micro lens 113-1 or 113-2 and the respective photodetection layer 112-1 or 112-3. Similarly, the trench may be in direct or not in direct contact with the photodetection layers 112-1 and 112-2 such that a further layer may or may not be arranged between them.

Light 104 enters the light detection system 100 via the lens stack 101 (e.g., camera objective lens) and propagates through the optical band-pass filter 102 and is, for example, incident on the first light detection device 103-1.

A part of the light may not be subject to photoelectric conversion in the photodetection layer 112-1 such that it may be reflected at the interface of the wiring layer 111 and the photodetection layer 112-1.

Some of the light reflected inside the light detection device 103-1 may propagate back to the optical band-pass filter 102 and the lens stack 101 where it may be reflected or scattered again such that it may reach the second light detection device 103-2 where it may be detected in the photodetection layer 112-2.

As generally known, each light detection device 103-1 and 103-2 detects light originating from a predetermined part of the field-of-view (“FOV”) of the light detection sensor.

Hence, a part of the incoming light 104 which should actually be detected by the first light detection device 103-1, as it originates from a specific part of the FOV associated with the first light detection device 103-1, and which is detected by the second light detection device 103-2, leads to an image or measurement artifact, since the light intensity detected by the second light detection device 103-2 does not correctly reflect the current scene or scene properties.

Referring now to FIG. 2, a traffic sign above a street is schematically depicted. The traffic sign is located in front of a dark or low-reflective background.

Assuming that a vehicle is equipped with an active light sensing system which emits lines of light 200 and processes the reflections, then the part of the light that hits the traffic sign is strongly reflected compared to the part of the light that is emitted towards the background.

This leads to a large amount of light incident on pixels that detect light originating from that part of the scene, while neighboring pixels should actually receive a low amount of light.

However, the reflected light from the traffic sign may cause some optical crosstalk such that it reaches also other neighboring pixels. This may lead to an image artifact, as schematically illustrated by the dotted area above and below the traffic sign. The traffic sign appears elongated, since the light signal indicates that there are some reflective objects in the areas, however, this light signal is caused by optical crosstalk.

Returning to the general explanations, as further mentioned in the outset, generally, the stray light should be reduced as much as possible, in particular, for applications involving safety features in order to increase a robustness of the safety feature.

It has been recognized that a design for a light detection device or light detection pixel may be provided which may reduce an influence of stray light or optical crosstalk on the light measurement of similar neighboring pixels or may reduce an amount of stray light or optical crosstalk caused by reflections inside the light detection pixel or light detection device.

In particular, in some embodiments, the design of the light detection device may manipulate the polarization of the light such that the stray light caused by the light detection device and incident on a similarly designed, neighboring light detection device may be removed before reaching a photodetection layer and, thus, the influence on the measurement may be reduced.

Hence, some embodiments pertain to a light detection device, wherein the light detection device includes a photodetection layer configured to perform photoelectric conversion on light with a predetermined wavelength, a linear polarizer and a quarter-wave plate, wherein the quarter-wave plate is configured to circularly polarize light that has passed through the linear polarizer.

The light detection device may be used as a pixel in a light detection pixel array such that the light detection device may also be referred to as light detection pixel.

When the light detection device is configured to be used in a ToF measurement, the light detection device may also be referred to, for example, as a time-of-flight pixel.

Typically, in some embodiments, the light detection device includes a stack of different, typically plate-shaped, layers in which a top surface of a lower layer is in contact with a bottom surface of a higher layer. The other surfaces of a layer, which are not in contact with a lower or a higher layer, are referred to herein as a lateral surface or the lateral surface.

The photodetection layer may be or may include, for example, a semiconductor layer, one or more semiconductor layers or a semiconductor device such that photoelectric conversion may occur.

A semiconductor device may be or may include an avalanche photodiode, a single-photon avalanche diode (“SPAD”), a current-assisted photonic demodulator (“CAPD”) or the like.

Hence, in some embodiments, the photodetection layer is or includes a SPAD.

The light detection device may thus be used in a direct ToF system (“dToF system”) or an indirect ToF system (“iToF system”).

The predetermined wavelength may be a wavelength in the visible spectral regions (typically ranging from 380 nanometers to 780 nanometers) or the infrared spectral region, in particular, the near-infrared spectral region (typically ranging from 780 nanometers to 3000 nanometers). The predetermined wavelength may be part of a wavelength range emitted by an active light source as described herein, for example, the active light source may include a VCSEL array such that a spectral width of the active emitted light may be roughly 10 nanometers in some embodiments and the predetermined wavelength may correspond to a center wavelength of that range, but without limiting the disclosure in this regard.

The linear polarizer may be or may include or may be based on a wire-grid polarizer, constructed from a birefringent material or a material exhibiting birefringent properties, a metasurface or the like.

The linear polarizer is configured to linearly polarize light with the predetermined wavelength.

The quarter-wave plate is configured to introduce a phase shift of 90 degrees between polarization components of the light passing through it, wherein the polarization components are perpendicular to each other.

The quarter-wave plate may be or may include or may be constructed from a birefringent material or a material exhibiting birefringent properties, a metasurface or the like.

Metasurfaces or optical metasurfaces are typically thin layers, e.g. plate-shaped, of a substrate and a plurality of nanostructures that are periodically arranged on the substrate and may have various shapes depending on the particular function the metasurface has been designed for.

A characteristic of metasurfaces is that the nanostructures typically have at least one spatial direction in which its dimension is in the subwavelength range such that the dimension is smaller than the target wavelength (here predetermined wavelength).

For example, when the target wavelength is in the visible or near-infrared range, the dimensions of the nanostructures may be about 50 nanometers in one direction and 200 nanometers in another direction. When the target wavelength is larger than 5 micrometers, for instance, the dimensions of the nanostructures may be about 1 micrometer in one direction and 4 micrometers in another direction. These are merely examples and are given only for illustration purposes, however, the present disclosure is not limited to such specific values.

The metasurfaces or optical metasurfaces for the linear polarizer and/or the quarter-wave plate may be plasmonic metasurfaces in some embodiments.

Typical functions of optical metasurfaces include a polarization function, a birefringence function, a phase shift function, a diffraction function, an optical band-pass filter function or the like.

Generally, any incoming light for the light detection device passes the linear polarizer and the quarter-wave plate before it is incident on the photodetection layer.

Incoming light corresponds to any light that is incident on the light detection device from particular directions and may correspond to active light reflected in a scene or internal stray light, for example, caused by neighboring light detection devices.

Thus, the incoming light may pass through or propagate through the linear polarizer before passing or propagating through the quarter-wave plate or vice versa.

As mentioned above, the light detection device includes a stack of different, typically plate-shaped, layers which are arranged on each other.

Generally, any light detection device or light detection sensor as described herein may be manufactured, for example, by a complementary metal-oxide-semicondutor (“CMOS”) process.

In some embodiments, the linear polarizer is arranged on a top surface of the photodetection layer, and the quarter-wave plate is arranged on a top surface of the linear polarizer, and incoming light passes through the quarter-wave plate before passing through the linear polarizer and before it is incident on the photodetection layer.

Generally, each layer (e.g., photo detection layer, quarter-wave plate, linear polarizer) may be in direct contact with the next layer or may include further other layers, for example, such as air gaps or other materials or other functional layers.

Hence, in some embodiments, the top surface of the photodetection layer is in direct contact with the linear polarizer, and the top surface of the linear polarizer is in direct contact with the quarter-wave plate, and incoming light passes through the quarter-wave plate before passing through the linear polarizer and before it is incident on the photodetection layer.

In some embodiments, the quarter-wave plate is arranged on a top surface of the photodetection layer, and the linear polarizer is arranged on a top surface of the quarter-wave plate, and incoming light passes through the linear polarizer before passing through the quarter-wave plater and before it is incident on the photodetection layer.

Generally, each layer (e.g., photo detection layer, quarter-wave plate, linear polarizer) may be in direct contact with the next layer or may include further other layers, for example, such as air gaps or dielectric materials or functional layers.

Hence, in some embodiments, the top surface of the photodetection layer is in direct contact with the quarter-wave plate, and the top surface of the quarter-wave plate is in direct contact with the linear polarizer, and incoming light passes through the linear polarizer before passing through the quarter-wave plater and before it is incident on the photodetection layer.

In some embodiments, the light detection device further includes an on-chip micro lens configured to direct incoming light onto the photodetection layer.

The on-chip micro lens may be made of or may include a glass or a plastic material or the like.

As mentioned above, the quarter-wave plate is configured to circularly polarize light that has passed through the linear polarizer.

Hence, the linear polarization of the linear polarizer and the alignment of the linear polarizer and the quarter-wave plate is such that it has an angle of 45 degrees with respect to a fast and slow axis of the quarter-wave plate.

Moreover, the quarter-wave plate is thus configured to linearly polarize such circular polarized light.

This structure allows to either reduce an influence of stray light or optical crosstalk on the light measurement of similar neighboring pixels or may reduce an amount of stray light or optical crosstalk caused by reflections inside the light detection pixel or light detection device.

The reason is that, in some embodiments, the stray light which comes from inside the pixel itself is typically caused by reflections at the interface of the photodetection layer and the wiring layer such that the stray light passes again through the linear polarizer and the quarter-wave plate such that the stray light is circularly polarized. The circularly polarized light then is reflected or scattered at the optical band-pass filter or a camera objective (e.g., lens stack) such that it reaches neighboring pixels. When it is incident on a neighboring pixel, the quarter-wave plate changes the circular polarization to a linear polarization which is perpendicular to the one of the linear polarizer.

In other embodiments, the reason is that the stray light caused by reflections at the interface of the photodetection layer and the wiring layer is already circularly polarized and is then linearly polarized to a polarization that is perpendicular to the one of the linear polarizer such that the linear polarizer blocks the light and prevents the light from leaving the light detection device.

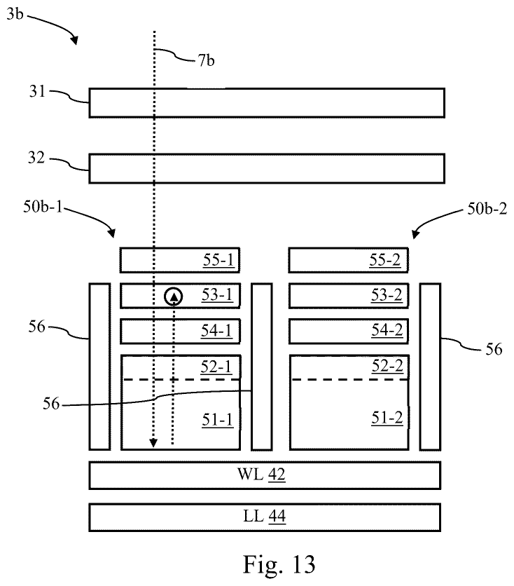

An embodiment of the working principle in some embodiments will also be discussed further below under reference of FIGS. 12 and 13.

The amount of stray light caused by or originating from or leaving a light detection device may be reduced by introducing a second quarter-wave plate.

Hence, in some embodiments, the light detection device further includes a second quarter-wave plate arranged such that the linear polarizer is sandwiched between the quarter-wave plate and the second quarter-wave plate, wherein, in particular, the second quarter-wave plate is configured to circularly polarize light that has passed through the linear polarizer.

Generally, each layer (e.g., quarter-wave plate, linear polarizer, second quarter-wave plate) may be in direct contact with the next layer or may include further other layers, for example, such as air gaps or dielectric materials or functional layers.

The amount of stray light caused by or originating from or leaving a light detection device may be further reduced by using a trench which is configured to block light with the predetermined wavelength.

Hence, in some embodiments, the light detection device further includes a trench which surrounds a lateral surface of the photodetection layer, in particular, wherein the trench further surrounds a lateral surface of the linear polarizer and the quarter-wave plate, in particular, wherein the trench entirely surrounds the lateral surface of the photodetection layer, the linear polarizer and the quarter-wave plate.

A trench may be a deep trench isolation structure. A deep trench isolation structure may extend into the semiconductor substrate and perimeterally surrounds the photodetection layer. Trenches or deep trenches for infrared imaging applications may be particularly important because the infrared light penetration depth in silicon is typically of 10 micrometers compared to about 3 micrometers for visible light.

The trench may also be referred to as pixel separation wall or light blocking wall or the like.

The trench may include a metal covered with an insulator so or a semiconductor structure or the like to block the light with the predetermined wavelength.

The amount of stray light caused by or originating from or leaving a light detection device may be reduced by introducing a textured surface on the photodetection layer, since this may increase a light path and, thus, a probability to be subject to photoelectric conversion.

Hence, in some embodiments, a top surface of the photodetection layer is a textured surface.

The texturing basically corresponds to any roughening of the top surface compared to a flat surface.

The top surface may be textured in various ways, for example, with small pyramids or inverted pyramids or the like. The pitch may be on the order of hundreds of nanometers for example, but without limiting the present disclosure in this regard. Such structures may be manufactured by known techniques such as lithography, anisotropic wet chemical etching and the like.

Some embodiments pertain to an active light sensing system, wherein the active light sensing system includes:
an active light source configured to emit light with a predetermined wavelength and a predetermined polarization;
a light detection device including:
   a photodetection layer configured to perform photoelectric conversion on light with the predetermined wavelength;
   a linear polarizer;
   a quarter-wave plate, wherein the quarter-wave plate is configured to circularly polarize light that has passed through the linear polarizer; and
wherein the linear polarizer and the quarter-wave plate are configured to let incoming light with the predetermined polarization pass.

Some embodiments pertain to an active light sensing system, wherein the active light sensing system includes:
an active light source configured to emit light with a predetermined wavelength and a predetermined polarization;
a light detection sensor including a plurality of light detection devices arranged in rows and columns, wherein each light detection device includes:
   a photodetection layer configured to perform photoelectric conversion on light with the predetermined wavelength;
   a linear polarizer;
   a quarter-wave plate, wherein the quarter-wave plate is configured to circularly polarize light that has passed through the linear polarizer; and
wherein the linear polarizer and the quarter-wave plate are configured to let incoming light with the predetermined polarization pass.

The active light sensing system may be, for example, a ToF system.

The active light source may be or may include a semiconductor laser or the like, optical elements such as polarization elements, phase shifting elements, reflective elements and lenses.

In some embodiments, the predetermined polarization is a circular polarization and the incoming light passes through the quarter-wave plate before passing through the linear polarizer.

In some embodiments, the predetermined polarization is a linear polarization and the incoming light passes through the linear polarizer before passing through the quarter-wave.

In some embodiments, the predetermined polarization is a circular polarization, and the light detection device further includes a second quarter-wave plate arranged such that the linear polarizer is sandwiched between the quarter-wave plate and the second quarter-wave plate.

The general explanations for the light detection device above, of course, also apply for light detection devices included in the active light sensing system.

Some embodiments pertain to a light detection sensor, including a plurality of light detection devices arranged in rows and columns, wherein each light detection device includes:
a photodetection layer configured to perform photoelectric conversion on light with the predetermined wavelength;
a linear polarizer;
a quarter-wave plate, wherein the quarter-wave plate is configured to circularly polarize light that has passed through the linear polarizer.

The general explanations for the light detection device above, of course, also apply for light detection devices included in the detection sensor.

Returning to FIG. 3, there is schematically illustrated in a block diagram an embodiment of an active light sensing system 1, which is discussed in the following.

The active light sensing system 1 is a ToF system, in particular, a direct ToF system which emits a trail of light pulses and measures the round-trip time of the light pulses to estimate the distance to objects in a scene.

The active light sensing system 1 includes an active light source 2, a light detection system 3 and a controller 4 for controlling and synchronizing the overall operation of the active light source 2 and the light detection system 3.

The active light source 2 emits light 5 to a scene 6, wherein the emitted light 5 has a predetermined wavelength and a predetermined polarization.

Typically, the direct ToF system uses light in the near-infrared spectral region, for example, the predetermined wavelength may be about 950 nanometers or the like. The predetermined polarization may be a linear polarization or a circular polarization.

The active light 5 may be reflected and scattered at objects in the scene 6 such that a part of emitted light 5 may become incoming light 7 for the light detection system 3.

Typically, the incoming light 7 has the same polarization as the emitted active light 5, but the scene 6 may partially depolarize the reflected light and, thus, the incoming light 7.

FIG. 4 schematically illustrates in a block diagram an embodiment of an active light source 2a, which is discussed in the following.

The active light source 2a is an embodiment of the active light source 2 of FIG. 3 and includes a semiconductor laser 21 (e.g., VCSEL (“Vertical-Cavity Surface Emitting Laser”) or edge emitting laser), a quarter-wave plate 23 and a projection lens 25.

The semiconductor laser 21 emits light 22 with a linear polarization.

The quarter-wave plate 23 is configured in such a way that it circularly polarizes the light 22 emitted by the semiconductor laser 21 such that light 24 that has passed through the quarter-wave plate 23 has a circular polarization.

The light 24 with a circular polarization is then projected onto the scene 6 as active light 5a, which is an embodiment of the active light 5 of FIG. 3.

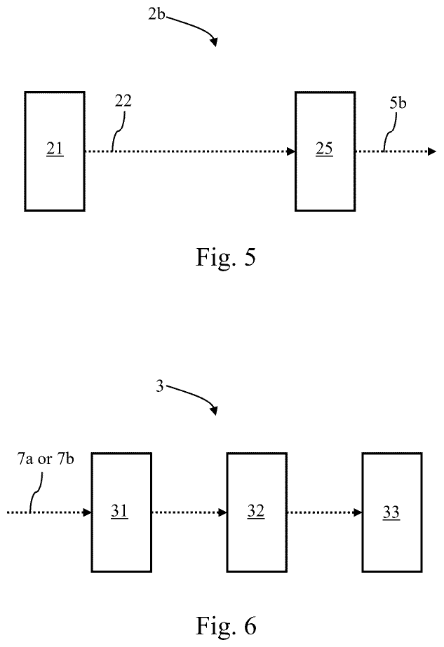

FIG. 5 schematically illustrates in a block diagram an embodiment of an active light source 2b, which is discussed in the following.

The active light source 2b is an embodiment of the active light source 2 of FIG. 3 and includes a semiconductor laser 21 (e.g., VCSEL (“Vertical-Cavity Surface Emitting Laser”) or edge emitting laser) and a projection lens 25.

The semiconductor laser 21 emits light 22 with a linear polarization.

The light 22 with a linear polarization is then projected onto the scene 6 as active light 5b, which is an embodiment of the active light 5 of FIG. 3.

FIG. 6 schematically illustrates in a block diagram an embodiment of the light detection system 3 of FIG. 3, which is discussed in the following.

The active light 5a or 5b, as embodiments of the active light 5 of FIG. 3, may be reflected or scattered in the scene 6 and may then become incoming light 7a or 7b, respectively, for the light detection system 3, wherein incoming light 7a has a circular polarization and incoming light 7b has a linear polarization.

The light detection system 3 includes a lens stack 31, a optical band-pass filter 32—here, e.g., a near-infrared bandpass filter centered around 950 nanometers—and a light detection sensor 33.

The incoming light 7a or 7b passes through the lens stack 31 which directs the incoming light 7a or 7b, respectively, on the light detection sensor 33, wherein the incoming light 7a or 7b passes the optical band-pass filter 32 before being incident on the light detection sensor 33.

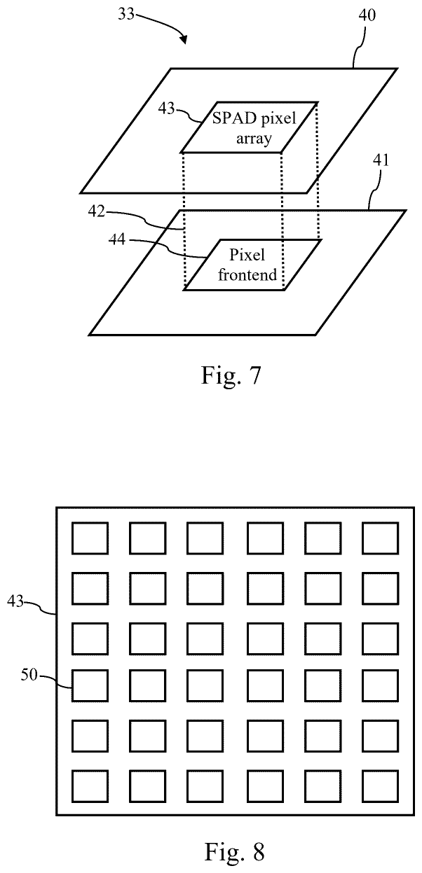

FIG. 7 schematically illustrates in a block diagram an embodiment of the light detection sensor 33 of FIG. 6, which is discussed in the following.

The light detection sensor 33 is here a SPAD sensor and has a stacked structure which includes a first tier 40 and a second tier 41 which are connected by a wiring layer 42, as schematically illustrated by the dotted lines.

The first tier 40 includes a SPAD pixel array 43 which includes a plurality of SPAD pixels arranged, for example, in rows and columns. A SPAD pixel corresponds here to a light detection device or light detection pixel.

The second tier 41 includes a logic layer 44 which includes, for example, some data processing and storage elements and a pixel frontend for counting light detection events from the SPAD pixel array 43.

FIG. 8 schematically illustrates in a block diagram an embodiment of the array of light detection devices 43 of FIG. 7 in a plan view, which is discussed in the following.

The array of light detection devices 43 includes a plurality of light detection devices 50 which is arranged in rows and columns.

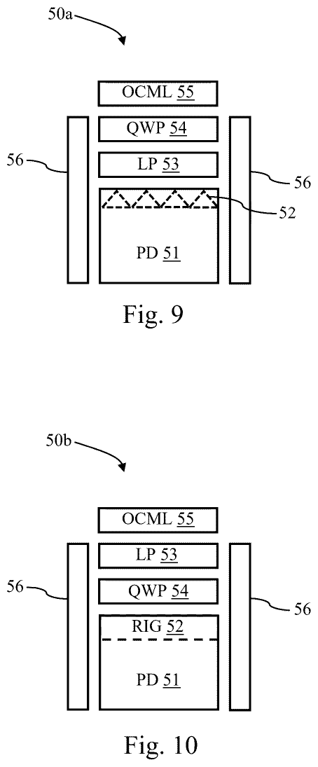

FIG. 9 schematically illustrates in a block diagram an embodiment of a light detection device 50a, which is discussed in the following.

The light detection device 50a is an embodiment of a light detection device 50 of FIG. 8.

The light detection device 50a includes a photodetection layer 51 (“PD”) that has a textured top surface, which is illustrated here as an intermediate layer 52 (“RIG”) by the dashed lines. The textured top surface includes small pyramids which increase a light path such that a probability for detection of the light in the photodetection layer 51 is increased compared to a flat top surface. The photodetection layer 51 is or includes a SPAD.

The light detection device 50a further includes a linear polarizer 53 (“LP”) arranged on the textured top surface of the photodetection layer 51.

The light detection device 50a further includes a quarter-wave plate 54 (“QWP”) arranged on a top surface of the linear polarizer 53.

The light detection device 50a further includes an on-chip micro lens 55 (“OCML”) arranged on a top surface of the quarter-wave plate 54. The on-chip micro lens 55 is configured to direct incoming light onto the photodetection layer 51. Any incoming light-incoming light for the light detection device 50a-passes through the on-chip micro lens 55, then through the quarter-wave plate 54 and then through the linear polarizer 53 such that the incoming light is finally incident on the photodetection layer 51.

The light detection device 50a further includes a trench 56 which surrounds a lateral surface of the photodetection layer 51 and a lateral surface of the linear polarizer 53 and the quarter-wave plate 54, in particular, the trench 56 entirely surrounds the lateral surface of the photodetection layer 51, the linear polarizer 53 and the quarter-wave plate 54 for reducing an amount of incoming light for the light detection device or pixel 50a to be also incident on a neighboring light detection device or pixel, since the trench 56 is configured to block light with the predetermined wavelength.

FIG. 10 schematically illustrates in a block diagram an embodiment of a light detection device 50b, which is discussed in the following.

The light detection device 50b is an embodiment of a light detection device 50 of FIG. 8.

The light detection device 50b basically corresponds to the light detection device 50a of FIG. 9, wherein the same reference signs indicate the same elements such that it is referred to FIG. 9 to avoid unnecessary repetition.

The difference between the light detection device 50b and the light detection device 50a of FIG. 9 is that the order of arrangement of the linear polarizer 53 and of the quarter-wave plate 54 is reversed.

In the light detection device 50b, the quarter-wave plate 54 is arranged on the textured top surface of the photodetection layer 51 and the linear polarizer 53 is arranged on the top surface of the quarter-wave plate 54 and, thus, the on-chip micro lens 55 is arranged on the top surface of the linear polarizer 53.

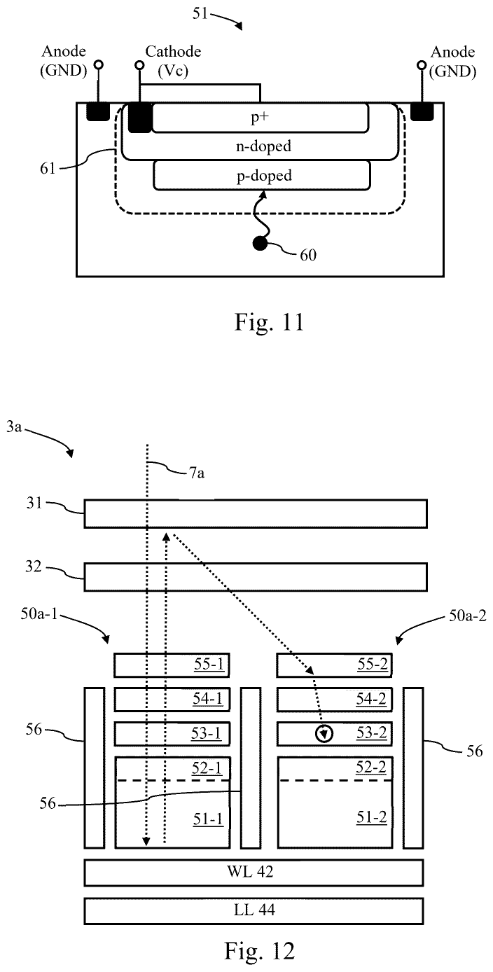

FIG. 11 schematically illustrates in a block diagram an embodiment of a SPAD which corresponds to or which is included in the photodetection layer 51 of FIGS. 9 and 10, which is discussed in the following.

When light is incident on the SPAD 51, a photo-generated electron 60 may be present and may diffuse into a depletion region 61 of the SPAD 51.

Once the photo-generated electron 60 reaches the depletion region 61, an avalanche process may occur in which further electrons are generated, as generally known, such that these electrons are typically driven towards the cathode causing a voltage drop at the cathode and an avalanche signal to be output by the SPAD 51 until the cathodic voltage Vc drops below the breakdown voltage and a bias voltage is restored again at the cathode.

FIG. 12 schematically illustrates in a block diagram an embodiment of a working principle of an embodiment of a light detection device 50a, which is discussed in the following.

The light detection system 3a is an embodiment of the light detection system 3 of FIGS. 3 and 6.

The light detection system 3a includes the lens stack 31, the optical band-pass filter 32 and the light detection sensor 33 of FIG. 7, which includes a plurality of light detection devices or pixels, the wiring layer 42 and the logic layer 44.

For the sake of illustration only, FIG. 12 shows only a first light detection device 50a-1 and a neighboring light detection device 50a-2 of the light detection sensor to illustrate a working principle of the light detection device 50a-1 or 50a-2.

The light detection devices 50a-1 and 50a-2 both correspond to the light detection device of FIG. 9.

In this embodiment, the active light source 2 of the active light sensing system of FIG. 3 corresponds to the active light source 2a of FIG. 4 which emits light 5a with a predetermined circular polarization.

Some of the emitted active light 5a becomes incoming light 7a for the light detection system 3a, for example, by reflection or scattering at the scene 6 (see FIG. 3).

Then, the incoming light 7a enters the light detection system 3a via the lens stack 31 and passes through the optical band-pass filter 32 and is, for example, incident on the first light detection device 50a-1.

Then, the incoming light 7a passes through the on-chip micro lens 55-1 which directs the incoming light 7a on the photodetection layer 51-1. On its way, the incoming light 7a passes through the quarter-wave plate 54-1 and then through the linear polarizer 53-1.

The quarter-wave plate 54-1 linearly polarizes the incoming light 7a with the predetermined circular polarization such that it matches with the linear polarization of the linear polarizer 53-1 and, thus, the linear polarizer 53-1 and the quarter-wave plate 54-1 are configured to let the incoming light 7a with the predetermined polarization, i.e. here the predetermined circular polarization, pass.

Hence, a SNR of the active light sensing system 1 may be improved, since incoming light is more likely to be incident on the photodetection layer 51-1 when it has the predetermined polarization, i.e. here the predetermined circular polarization, as otherwise the polarization after the quarter-wave plate 54-1 would not match with the one of the linear polarizer 53-1 such that it would at least partially be blocked by the linear polarizer 53-1.

Accordingly, some of the incoming light 7a may be incident on the photodetection layer 51-1.

A part of the light may not be subject to photoelectric conversion in the photodetection layer 51-1 such that it may be reflected at the interface of the wiring layer 42 and the photodetection layer 51-1.

Some of the light reflected inside the light detection device 50a-1 may propagate back through the structure of the first light detection device 50a-1 and, thus, in a reversed order such that the internally reflected light passes through the linear polarizer 53-1 and then passes through the quarter-wave plate 54-1.

The linear polarizer 53-1 and the quarter-wave plate 54-1 are aligned in such a way that the linear polarization after the linear polarizer 53-1 corresponds to an angle of 45 degrees with respect to a fast and a slow axis of the quarter-wave plate 54-1.

Hence, the quarter-wave plate 54-1 is configured to circularly polarize light that has passed through the linear polarizer 53-1.

The now circularly polarized light propagates back through to the optical band-pass filter 32 and the lens stack 31 where it may be reflected or scattered again such that it may be incident on the second light detection device 50a-2 which is, however, identical in structure as the first light detection device 50a-1.

The internally reflected light, which may also be referred to as stray light or optical crosstalk, thus now passes through the quarter-wave plate 54-2.

As the quarter-wave plate 54-2 introduces the same phase shift as the quarter-wave plate 54-1, the polarization of the stray light is changed from circular polarization to linear polarization, however, the linear polarization of the stray light is then 90 degrees or vertical to the linear polarization of the linear polarizer 53-2 such that it is blocked by the linear polarizer 53-2 before reaching the photodetection layer 51-2.

Hence, the stray light is removed and does not cause an image or measurement artifact.

The structure of the light detection device 50a-1 thus reduces an influence of the stray light on the measurement of similar neighboring light detection devices.

FIG. 13 schematically illustrates in a block diagram an embodiment of a working principle of an embodiment of a light detection device 50b, which is discussed in the following.

The light detection system 3b is an embodiment of the light detection system 3 of FIGS. 3 and 6.

The light detection system 3b includes the lens stack 31, the optical band-pass filter 32 and the light detection sensor 33 of FIG. 7, which includes a plurality of light detection devices or pixels, the wiring layer 42 and the logic layer 44.

For the sake of illustration only, FIG. 12 shows only a first light detection device 50b-1 and a neighboring light detection device 50b-2 of the light detection sensor to illustrate a working principle of the light detection device 50b-1 or 50b-2.

The light detection devices 50b-1 and 50b-2 both correspond to the light detection device of FIG. 10.

In this embodiment, the active light source 2 of the active light sensing system of FIG. 3 corresponds to the active light source 2b of FIG. 4 which emits light 5b with a predetermined linear polarization.

Some of the emitted active light 5b becomes incoming light 7b for the light detection system 3b, for example, by reflection or scattering at the scene 6 (see FIG. 3).

Then, the incoming light 7b enters the light detection system 3b via the lens stack 31 and passes through the optical band-pass filter 32 and is, for example, incident on the first light detection device 50b-1.

Then, the incoming light 7b passes through the on-chip micro lens 55-1 which directs the incoming light 7b on the photodetection layer 51-1. On its way, the incoming light 7b passes through the linear polarizer 53-1 and then through the quarter-wave plate 54-1.

The predetermined linear polarization of the incoming light 7b matches with the linear polarization of the linear polarizer 53-1.

Hence, a SNR of the active light sensing system 1 may be improved, since incoming light is more likely to be incident on the photodetection layer 51-1 when it has the predetermined polarization, i.e. here the predetermined linear polarization, as otherwise the polarizations would not match such that the incoming light 7b would at least partially be blocked by the linear polarizer 53-1.

Then, the incoming light 7b passes through the quarter-wave plate 54-1 which to circularly polarize light that has passed through the linear polarizer 53-1.

Accordingly, some of the incoming light 7b may be incident on the photodetection layer 51-1.

A part of the light may not be subject to photoelectric conversion in the photodetection layer 51-1 such that it may be reflected at the interface of the wiring layer 42 and the photodetection layer 51-1.

Some of the light reflected inside the light detection device 50b-1 may propagate back through the structure of the first light detection device 50b-1 and, thus, in a reversed order such that the internally reflected light passes through the quarter-wave plate 54-1 and then passes through the linear polarizer 53-1.

As the stray light passes a second time through the quarter-wave plate 54-1, the polarization of the stray light is now linear again, but 90 degrees or vertical with respect to the polarization of the linear polarizer 53-1 such that the stray light is blocked by the linear polarizer 53-1.

Hence, the stray light may be prevented from leaving the light detection device 50b-1 to be incident on neighboring pixels, for example, the light detection device 50b-2 and, thus, the structure of the light detection device 50b-1 or 50b-2 reduces an amount of stray light or optical crosstalk caused by reflections inside the light detection pixel or light detection device itself.

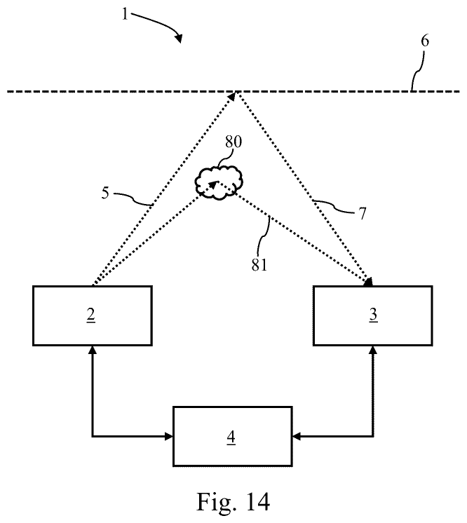

FIG. 14 schematically illustrates in a block diagram an embodiment of a working principle of an embodiment of the active light sensing system 1 of FIG. 3, which is discussed in the following.

In this example, it is assumed that fog 80 is present and some of the emitted light 5 is scattered by the fog 80 to become incoming light 81 for the light detection system 3 and some of the emitted light 5 is reflected at the scene 6 to become incoming light 7 for the light detection system 3.

The fog 80 depolarizes the active light 5 such that a detection probability is reduced in the light detection devices of the light detection system 3, since the probability to be incident on the photodetection layer 51 is highest when the polarization of incoming light corresponds to a predetermined polarization.

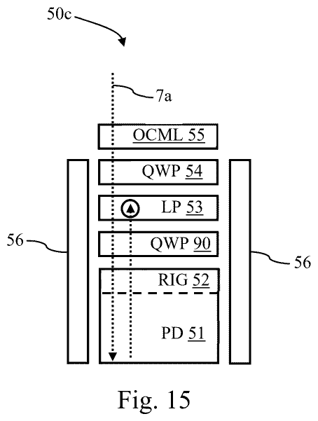

FIG. 15 schematically illustrates in a block diagram an embodiment of a light detection device 50c, which is discussed in the following.

The light detection device 50c is an embodiment of a light detection device 50 of FIG. 8.

The light detection device 50c basically corresponds to the light detection device 50a of FIG. 9, wherein the same reference signs indicate the same elements such that it is referred to FIG. 9 to avoid unnecessary repetition.

The difference between the light detection device 50c and the light detection device 50a of FIG. 9 is that the light detection device 50c further includes a second quarter-wave plate 90 such that that the linear polarizer 53 is sandwiched between the quarter-wave plate 54 and the second quarter-wave plate 90.

The second quarter-wave plate 90 is configured to circularly polarize light that has passed through the linear polarizer 53.

Hence, also for incoming light 7a with the predetermined circular polarization, the stray light may be prevented from leaving the light detection device 50c to be incident on neighboring pixels, since light that is reflected at the interface of the photodetection layer 51 and the wiring layer 42 (not shown) is blocked by the linear polarizer 53, as it has passed through the second quarter-wave plate two times such that the polarization is now linear and 90 degrees with respect to the polarization of the linear polarizer 53, as also discussed with respect to FIG. 13 above.

While certain embodiments have been described with respect to the drawings in which certain combinations of technical features are shown, such combinations should not be construed as binding and the skilled person will recognize that at least some of the technical features may be provided or removed from the embodiments independently from each other and at least some of the technical features of one embodiment may be combined with technical features of another embodiment.

The above description of embodiments is given by way of example and the skilled person will recognize that various modifications of the described technology may be made within the scope of the appended claims. The embodiments are not limited to those that solve all of the stated problems or those that have all of the stated benefits, advantages and technical effects. Variants should be considered to be included within the scope of the appended claims.

The benefits, advantages and technical effects described herein may relate to one embodiment or several embodiments. Further technical effects, in addition to the technical effects described herein, may occur.

Note that the present technology can also be configured as described below.

(1) A light detection device, wherein the light detection device includes:
a photodetection layer configured to perform photoelectric conversion on light with a predetermined wavelength;
a linear polarizer; and
a quarter-wave plate, wherein the quarter-wave plate is configured to circularly polarize light that has passed through the linear polarizer.

(2) The light detection device of (1), wherein the photodetection layer includes a single-photon avalanche diode.

(3) The light detection device of (1) or (2), further including a trench which surrounds a lateral surface of the photodetection layer.

(4) The light detection device of (3), wherein the trench further surrounds a lateral surface of the linear polarizer and the quarter-wave plate.

(5) The light detection device of (4), wherein the trench entirely surrounds the lateral surface of the photodetection layer, the linear polarizer and the quarter-wave plate.

(6) The light detection device of any one of (1) to (5), wherein the trench is configured to block light with the predetermined wavelength.

(7) The light detection device of any one of (1) to (6), further including an on-chip micro lens configured to direct incoming light onto the photodetection layer.

(8) The light detection device of any one of (1) to (7), wherein a top surface of the photodetection layer is a textured surface.

(9) The light detection device of any one of (1) to (8), further including a second quarter-wave plate arranged such that the linear polarizer is sandwiched between the quarter-wave plate and the second quarter-wave plate.

(10) The light detection device of (9), wherein the second quarter-wave plate is configured to circularly polarize light that has passed through the linear polarizer.

(11) An active light sensing system, wherein the active light sensing system includes:
an active light source configured to emit light with a predetermined wavelength and a predetermined polarization;
a light detection device including:
   a photodetection layer configured to perform photoelectric conversion on light with the predetermined wavelength;
   a linear polarizer;
   a quarter-wave plate, wherein the quarter-wave plate is configured to circularly polarize light that has passed through the linear polarizer; and
wherein the linear polarizer and the quarter-wave plate are configured to let incoming light with the predetermined polarization pass.

(12) The active light sensing system of (11),
wherein the predetermined polarization is a circular polarization and the incoming light passes through the quarter-wave plate before passing through the linear polarizer, or
wherein the predetermined polarization is a linear polarization and the incoming light passes through the linear polarizer before passing through the quarter-wave.

(13) The active light sensing system of (11) or (12), wherein the photodetection layer includes a single-photon avalanche diode.

(14) The active light sensing system of any one of (11) to (13), wherein the light detection device further includes a trench which surrounds a lateral surface of the photodetection layer.

(15) The active light sensing system of (14), wherein the trench further surrounds a lateral surface of the linear polarizer and the quarter-wave plate.

(16) The active light sensing system of (15), wherein the trench entirely surrounds the lateral surface of the photodetection layer, the linear polarizer and the quarter-wave plate.

(17) The active light sensing system of any one of (11) to (16), wherein the trench is configured to block light with the predetermined wavelength.

(18) The active light sensing system of any one of (11) to (17), wherein the light detection device further includes an on-chip micro lens configured to direct incoming light onto the photodetection layer.

(19) The active light sensing system of any one of (11) to (18), wherein a top surface of the photodetection layer is a textured surface.

(20) The active light sensing system of any one of (11) to (19), wherein the predetermined polarization is a circular polarization, and wherein the light detection device further comprises a second quarter-wave plate arranged such that the linear polarizer is sandwiched between the quarter-wave plate and the second quarter-wave plate.

(21) The light detection device of any one of (1) to (10), wherein the light detection device is a light detection pixel.

(22) The light detection device of any one of (1) to (10) or (21), wherein the linear polarizer is a metasurface and the quarter-wave plate is a metasurface.

(23) The light detection device of any one of (1) to (10) or (21) or (22), wherein the light detection device is manufactured by a complementary metal-oxide-semiconductor process.

(24) A light detection sensor, including a plurality of light detection devices arranged in rows and columns, wherein each light detection device includes:
a photodetection layer configured to perform photoelectric conversion on light with the predetermined wavelength;
a linear polarizer;
a quarter-wave plate, wherein the quarter-wave plate is configured to circularly polarize light that has passed through the linear polarizer.

(25) The light detection sensor of (24), wherein each light detection device is a light detection pixel.

(26) The light detection sensor of (24) or (25), wherein each linear polarizer is a metasurface and each quarter-wave plate is a metasurface.

(27) The light detection sensor of any one of (24) to (26), wherein the light detection sensor is manufactured by a complementary metal-oxide-semiconductor process.

(28) An active light sensing system including:
an active light source configured to emit light with a predetermined wavelength and a predetermined polarization;
a light detection sensor including a plurality of light detection devices arranged in rows and columns, wherein each light detection device includes:
   a photodetection layer configured to perform photoelectric conversion on light with the predetermined wavelength;
   a linear polarizer;
   a quarter-wave plate, wherein the quarter-wave plate is configured to circularly polarize light that has passed through the linear polarizer; and
wherein the linear polarizer and the quarter-wave plate are configured to let incoming light with the predetermined polarization pass.

(29) The active light sensing system of any one of (11) to (20) or (28), wherein each light detection device is a light detection pixel.

(30) The active light sensing system of any one of (11) to (20) or (28) or (29), wherein each linear polarizer is a metasurface and each quarter-wave plate is a metasurface.

(31) The active light sensing system of any one of (11) to (20) or (28) to (30), wherein the light detection sensor is manufactured by a complementary metal-oxide-semiconductor process.

1. A light detection device comprising:
a photodetection layer configured to perform photoelectric conversion on light with a predetermined wavelength;
a linear polarizer; and
a quarter-wave plate, wherein the quarter-wave plate is configured to circularly polarize light that has passed through the linear polarizer.

2. The light detection device of claim 1, wherein the photodetection layer includes a single-photon avalanche diode.

3. The light detection device of claim 1, further comprising a trench which surrounds a lateral surface of the photodetection layer.

4. The light detection device of claim 3, wherein the trench further surrounds a lateral surface of the linear polarizer and the quarter-wave plate.

5. The light detection device of claim 4, wherein the trench entirely surrounds the lateral surface of the photodetection layer, the linear polarizer and the quarter-wave plate.

6. The light detection device of claim 1, wherein the trench is configured to block light with the predetermined wavelength.

7. The light detection device of claim 1, further comprising an on-chip micro lens configured to direct incoming light onto the photodetection layer.

8. The light detection device of claim 1, wherein a top surface of the photodetection layer is a textured surface.

9. The light detection device of claim 1, further comprising a second quarter-wave plate arranged such that the linear polarizer is sandwiched between the quarter-wave plate and the second quarter-wave plate.

10. The light detection device of claim 9, wherein the second quarter-wave plate is configured to circularly polarize light that has passed through the linear polarizer.

11. An active light sensing system comprising:
an active light source configured to emit light with a predetermined wavelength and a predetermined polarization;
a light detection device including:
a photodetection layer configured to perform photoelectric conversion on light with the predetermined wavelength;
a linear polarizer;
a quarter-wave plate, wherein the quarter-wave plate is configured to circularly polarize light that has passed through the linear polarizer; and
wherein the linear polarizer and the quarter-wave plate are configured to let incoming light with the predetermined polarization pass.

12. The active light sensing system of claim 11,
wherein the predetermined polarization is a circular polarization and the incoming light passes through the quarter-wave plate before passing through the linear polarizer, or
wherein the predetermined polarization is a linear polarization and the incoming light passes through the linear polarizer before passing through the quarter-wave.

13. The active light sensing system of claim 11, wherein the photodetection layer includes a single-photon avalanche diode.

14. The active light sensing system of claim 11, wherein the light detection device further includes a trench which surrounds a lateral surface of the photodetection layer.

15. The active light sensing system of claim 14, wherein the trench further surrounds a lateral surface of the linear polarizer and the quarter-wave plate.

16. The active light sensing system of claim 15, wherein the trench entirely surrounds the lateral surface of the photodetection layer, the linear polarizer and the quarter-wave plate.

17. The active light sensing system of claim 11, wherein the trench is configured to block light with the predetermined wavelength.

18. The active light sensing system of claim 11, wherein the light detection device further includes an on-chip micro lens configured to direct incoming light onto the photodetection layer.

19. The active light sensing system of claim 11, wherein a top surface of the photodetection layer is a textured surface.

20. The active light sensing system of claim 11, wherein the predetermined polarization is a circular polarization, and wherein the light detection device further comprises a second quarter-wave plate arranged such that the linear polarizer is sandwiched between the quarter-wave plate and the second quarter-wave plate.
